(19) United States
(12) Patent Application Publication
(10) Pub. No.: US 2009/0314674 A1
(43) Pub. Date: Dec. 24, 2009

(54) TOOL CASE

(76) Inventor: James Earl Sauerheber, Seymour, IN (US)

Correspondence Address: INDIANO VAUGHAN LLP, ONE N. PENNSYLVANIA STREET, SUITE 1300, INDIANAPOLIS, IN, 46204, US

(21) Appl. No.: 12/487,520

(22) Filed: Jun. 18, 2009

Related U.S. Application Data
(60) Provisional application No. 61/073,698, filed on Jun. 18, 2008.

(51) Int. Cl. B25H 3/02

(52) U.S. Cl. 206/373; 220/4.22

(57) ABSTRACT

A case for holding a plurality of construction tools includes a first shell half and a second shell half. The first shell half has a first exterior portion and a first interior portion. The first interior portion defines a plurality of cavities sized and shaped for receiving construction tools. The second shell half has a second exterior portion and a second interior portion. A hinge hingedly couples the first shell half to the second shell half for permitting the first and second shell halves to move relative to each other between a closed position and an opened position. A retaining protrusion is disposed on the interior portion and is engagable with the construction tools for retaining a construction tool in at least one of the plurality of cavities.

### I. PRIORITY OF INVENTION

This application claims the benefit of Sauerheber, U.S. Provisional Patent Application No. 61/073,698 which was filed on 18 Jun. 2008, which provisional patent application is fully incorporated herein by reference.

### II. TECHNICAL FIELD OF THE INVENTION

The present invention relates to a tool case, and more particularly, to a tool case that is especially well adapted to carrying construction-related tools.

### III. BACKGROUND OF THE INVENTION

In the construction industry, the work performed by construction workers is almost always performed at the site at which a building or structure is being constructed. As such, construction workers must usually transport themselves to the construction site, rather than the site being brought to the construction worker's place of business. Not only must the construction worker transport himself to the site, but he must also transport whatever tools he will need to perform his particular job at the site.

Transporting these tools to a site can provide a challenge to the worker. In some cases, a challenge is provided by the number of tools that a worker must transport. In other cases, a challenge is provided the size and weight of the tools that must be transported. In any event, where multiple tools are required, a challenge is provided to the worker to keep his tools organized at the site, both to ensure that he does not lose the tools, and also to ensure that the tools are readily available and handy to the worker when she needs them.

Unfortunately, many tools, and especially tools of the type used by concrete workers, are not provided with organizers or carrying cases for facilitating the transportation of the tools. To get around this lack of an available transport mechanism, construction workers often improvise. One way in which some workers improvise is to acquire a bucket, such as a five gallon paint bucket. The construction worker can then place his tools in the five gallon paint bucket for transportation to and from the site. The handle on the bucket enables the user to carry the bucket from his car or truck to the jobsite.

Although a five gallon paint bucket does work well for carrying tools between the construction worker's truck and the particular place on the job site where the work is being performed, it also has its drawbacks. One of these drawbacks is that a five gallon paint bucket does not do a good job of protecting the tools against the bumps, jolts, jiggles and movement of the vehicle in which the bucket and tools are placed, as the vehicle travels between the construction worker's home and the job site.

Because of the nature of construction work, one would expect construction tools to be especially rugged, and largely immune to damage from being jostled inside the bed of a moving truck. With many tools, this is the case. Surprisingly, many tools that are intended for use for heavy-duty purposes and are subjected to heavy wear and tear, have some degree of frailty to them. Such tools are subject to being nicked, bent, scratched, cracked or otherwise damaged during transport. Such damage can also reduce the effectiveness of the tool.

Nicking and chipping in particular, can be especially deleterious to tools used by a worker to lay concrete. For example, many concrete tools are used by a worker to place particular desired surface features on a pad of fresh, molten concrete. One example of such a surface treating tool is a “bull float”. A bull float is a tool that includes a broad-faced, generally planar surface-engaging member that is drawn across the surface of a slab to place a smooth edge and surface on the concrete. However, if the edge of a bull float becomes nicked or bent, this nicked or bent edge will manifest itself in the concrete, and often will cause a concrete slab treated with such a nicked or dented bull float to develop an unintended trough or ridge that conforms to the nicked or dented area of the bull float.

If there is an inward bend in the bull float, it is likely that a pyramid-shaped ridge will occur in the concrete over which the bull float is being pulled. A ridged imperfection in the surface can be both an aesthetic and a structural problem. Economically, such issues often draw the ire of structure owners, and require the concrete company to devote additional time and resources to correct the imperfection.

Because of this and other problems, it is not unusual for bull floats to “wear out” in a short period of time, thereby requiring the construction worker to replace the bull float. For example, it is not unusual for a typical construction worker to wear out four or five bull floats during a construction season. This need to replace bull floats reduces the construction worker's profitability because of the expense in replacing the bull floats. For example, a good quality, 36-inch bull float will often retail for about $150.00 (2008 prices). As such, the need to replace five bull floats during a construction season will cost the construction worker about $750.00 per season.

A primary cause of nicks, dings, bends and distortions on bull floats is metal on metal contact with other tools. Typically, a bull float has a surface comprised of a soft metal, such as aluminum or magnesium. Contact between the soft metal of a bull float, and the hard metal of other tools, that are often made out of steel can cause the harder metal tool (e.g. a hammer) to dent the metal of the softer metal tool (the bull float).

When a plurality of varied tools are placed by a worker in a five gallon bucket or similar container that is devoid of separators for separating the tools, the movement of the bucket can cause jostling among the tools. This jostling can result in dented tools, and especially dented bull floats. It will be appreciated that jostling is especially accentuated during the transport of tools in a truck over roughened surfaces of the type often encountered at construction sites.

In addition to the bull float discussed above, other tools used by concrete workers are also subject to becoming broken, dinged or dented during transport. These other tools include such things as brooms, edgers measuring tapes, trowels and the like.

One object of the present invention is to provide a case for carrying tools that helps to organize the worker's tools and stores the tools within the case in a manner that helps to prevent damage to the tools, to thereby preserve the tools for a longer period of time.

### III. SUMMARY OF THE INVENTION

In accordance with the present invention, a case is provided for holding a plurality of construction tools. The case comprises a first shell half having a first exterior portion and a first interior portion. The first interior portion defines a plurality of cavities that are sized and shaped for receiving construction tools. A second shell half is provided that has a second exterior portion and a second interior portion portion. A hinge is provided for hingedly coupling the first shell half to the second shell half for permitting the first and second shell halves to move relative to each other between a closed position and an open position. A retaining protrusion is disposed on the interior portion and is engagable with a construction tool for retaining a construction tool in at least one of the plurality of cavities.

Preferably, the first interior portion includes an upper surface disposed in a plane, where the at least one cavity of the plurality of cavities includes a base portion disposed in a plane angled from the plane of the upper surface. Additionally, the at least one cavity includes a sidewall portion, with the retaining protrusion being disposed on the sidewall portion to extend outwardly therefrom.

The retaining protrusion is preferably disposed adjacent to the angled base portion, and is sized and positioned for engaging a blade of a construction tool.

One feature of the present invention is that a plurality of retaining protrusions are used. The retaining protrusions have the advantage of being able to snugly hold the tools within their cavities, so that the tools will not fall out of their cavities, or otherwise become dislodged from their cavities when, for example, the two halves of the shell casing are moved between their closed position and opened position.

Another feature of the present invention is that both the first shell half and the second shell half include a plurality of cavities for receiving various tools. By enabling both shell halves to include a plurality of cavities, a greater variety of tools can be carried by the case than, for example, if cavities were only found in one of the two shell halves of the case.

Another feature of the present invention is that the case may include a plurality of handle members, including handle members disposed on only the long sides of the case, along with handle members that are disposed on one or both of the “short sides” of the case.

The long side handle(s) enable the case to be carried by a single person who is walking. The handles on the short end of the case preferably comprise a pair of handles on opposed short sides of the case. The pair of handles on the short side of the tool case, which at times can be quite heavy, enables the tool-laden case to be carried by two people, thereby making the case easier to transport, especially when it is being transported over long distances. In a most preferred embodiment of the present invention, one of the short side handles can be grabbed by a user to help pull a wheeled version of the case along the ground.

One feature found in one particular embodiment of the case is that the interior member, that defines the cavities is manufactured separately from the outer shell member. This feature has certain manufacturing advantages, insofar as it permits the manufacturer to make a variety of differently configured cases, by using a single outer shell casing, to which one of a variety of interior portions can be mated.

Another feature of the present invention is that in another embodiment of the present invention, a foam member can be used as the interior portion. The foam member can be provided with either pre-cut cavities for the user, or alternately, can comprise a single block of foam, so that the user can form cavities in the foam to fit the particular tools that he has in his case. In this variation also, the same exterior shells can be mated at different inserts, to adapt the case to carry tools of varying types, and for varying trades.

### IV. BRIEF DESCRIPTION OF THE DRAWINGS

FIG. 1 is an exploded, perspective view showing the tool case of the present invention along with exemplary tools that may be carried by the case;

FIG. 2A is a perspective view showing the open case of the present invention;

FIG. 2B is a perspective view, similar to FIG. 2A except showing tools contained within the interior of the case;

FIG. 3 is a top plan view of the open case;

FIG. 4 is a schematic view showing a hinge for hingedly coupling the first and second shell halves;

FIG. 5 is a sectional view taken along lines 5-5 of FIG. 3;

FIG. 6 is a perspective view of the case of the present invention in a closed position;

FIG. 7 is a first alternate embodiment construction of the case showing a case such as one might make through a vacuum forming process;

FIG. 8 is a second alternate embodiment construction of the case, showing the interior member comprised of a solid foam block;

FIG. 9 is a sectional view similar to the embodiment shown in FIG. 8, showing tools inserted therein; and

FIG. 10 is third alternate embodiment of the case, showing a wheeled version thereof.

### V. DETAILED DESCRIPTION OF THE PREFERRED EMBODIMENT

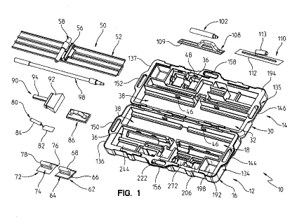

A case 10 is shown in the drawings for holding a plurality of construction tools, and preferably concrete working tools, such as the concrete working tools shown in FIG. 1, that will be described in more detail below.

The case 10 comprises a first shell half 12, and a second shell half 14. The first shell half 12 includes a first exterior portion 16 that comprises the outer shell of the first shell half 12. First shell half 12 also includes a first interior portion 18. First interior portion 18 includes a plurality of cavities, including cavities 20 and 22, and others that will be discussed in more detail below.

The second shell half 14 is generally identical to the first shell half 12 and also includes a second exterior portion 30, and a second interior portion 32. Generally, the second exterior portion 30 is generally identical to the first exterior portion 16.

Although second interior portion 32 can be constructed identically to the first interior portion 18, the second interior portion and first interior portion can also be configured to have different arrays of cavities therein. The second interior portion 32 includes cavities including cavity 36 and cavity 38.

The cavities 22, 24, 36, 38 and others are provided for receiving a plurality of construction tools.

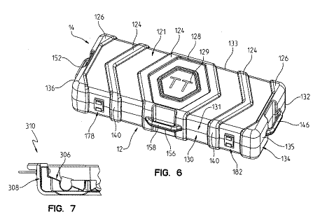

A hinge 42 is provided for hingedly coupling the first shell half 12 and the second shell half 14, so that the shell halves 12, 14 can move between an open position, as shown in FIG. 1, and a closed position as shown in FIG. 6. In the open position, the first and second shell halves 12, 14 are disposed in a generally co-planar configuration. When in the closed position, the first and second shell halves 12, 14 are positioned in parallel planes, so that the cavities 20, 22, 36, 38 are interiorly disposed within the case 10 and the tools contained therein are enclosed within the interior of the case 10. When so positioned in the closed position, the tools can be easily transported without the fear that tools will fall out of the case 10.

Some of the cavities include retaining protrusions, such as retaining protrusions 46. Retaining protrusions 46 are positioned for engaging the tools contained in the cavities. By engaging the tools, the retaining protrusions 46 can help to maintain the tools within their appropriate cavities. This retention in the cavities is especially important when the shell halves 12, 14 are moved between their open and closed positions. As will be appreciated, when the shell halves are so moved, the tools would otherwise likely fall out of their respective cavities, under the influence of gravity.

In order to understand the shape, size and configuration of the various cavities 22, 24, 36, 38 within the shell halves 12, 14, it is useful and helpful to understand something about the tools that are disposed therein. Since the cavities are generally sized, shaped and configured for receiving particular tools. Examples of various concrete working tools, that are particularly well adapted for being carried in the case 10 of the present invention are shown in FIG. 1.

The first tool comprises a bull float 50. The bull float 50 includes a sheet-like head portion 52, that preferably has a generally planar lower surface. The bull float 50 is used to smooth out the upper surface of a newly poured concrete pad. The bull float 50 includes a handle bracket 56 that is provided for coupling a handle 58 to the sheet-like hand portion 52. Handle 58 can be of various lengths. However, in most cases, handle 58 is sized to generally be short, but to be matable with a longer handle, such as broom-like handle 98. The combined handle 58 and broom handle 98 preferably have a length that is typical of a push broom handle, thereby enabling the user to stand while passing the bull float 50 over the upper surface of the recently poured concrete.

A groover 62 is another tool. The groover 62 has a generally planar head 64, that contains a downwardly extending perpendicular ridge 66 for forming a groove in the surface of the concrete over which the groover 62 is run. A hand-engagable handle 68 is coupled to the upper surface of the generally sheet-like head 64 of the groover 62.

An edger 72 is generally similar to the groover 62, except that the sheet-like head member 74 is configured somewhat differently. An edger 72 has a generally planar head 74, with no perpendicular ridge running down the center of the edger 72. Rather, it will typically have a perpendicular, downwardly turned flange 76 disposed at one side of the edger 72, blade 74. A handle 78 is provided to enable the user to grip the edger.

As the handles 68, 70 of the groover 62 and the edger 72 are disposed relatively close to the heads 64, 74 thereof, it will be appreciated that the edger and groover are not generally intended for use in the standing position. A trowel 80 having a blade portion 82 and a handle 84 is also shown.

In addition to the bull float 50, the case 10 will typically be designed to carry a smaller, hand controlled floats, that are smaller in size than the larger size, broom handle controlled bull float 50. A small float 86 is shown that is generally about the same size as the edger 62, and groover 72. In each case, the edger 62, groover 72 and small float 86 are about five to eight inches in length or so, and probably about the same size in width.

A small broom 90 is provided for enabling the user to broom off the concrete surface after it is smooth. Small broom 90 includes a brush-containing broom head 92 and a handle 94 for the user to grip. The handle 94 is relatively short, and the small broom 90 is probably about the length of an average whisk-type broom. A long broom handle 98 is employed, that can either be attached to the bull float 50, or alternately can be attached to an actual broom, such as a push broom.

A first hand float 108 is shown that includes a sheet-like base member 109; along with a second hand float 110, that is shown as also including a sheet-like base 112 and a handle 113. The primary differences between the two hand floats 108, 110 is in the shape and configuration of their handles.

As will be noticed, the largest portions of most of the tools is their base portions. As such, the cavities must be sized to accept these base portions.

The exterior portion 16, 30 of the first and second shell halves 12, 14 are generally similar in configuration. As such, unless otherwise noted, comments and descriptions made about the exterior portion 16 of the first shell half 12, will be equally applicable to the second exterior portion 30 of the second shell half 14.

The shell half exteriors can best be understood with respect to FIGS. 1, 2A, 2B, 3 and 6. In a preferred embodiment, the exterior portions 16, 30 of the shell halves, are unitarily formed with their respective interior portions 18, 32 of the first and second shell halves 12, 14. That is, each shell half 12, 14 preferably comprises a unitarily formed piece of plastic. Presently, it is believed that the best method for making such shell halves 12, 14 is through a rotational molding process.

Each shell half is rather large (when used for holding concrete tools), due to the generally large size of the concrete tools that are held by the case 10. In an exemplary, most preferred embodiment, each shell half 12, 14 will have a length of about 5 feet, a width of about 22 inches, and a depth of about 5 inches. As such, when the first and second shell halves 12, 14 are placed in the closed position, as shown in FIG. 6, the case 10 will have a depth of approximately 10 inches.

The exterior portions 16, 30 of the first and second shell halves 12, 14 each include base portions 120, 121. In a most preferred embodiment, the base portions 120, 121 have a width of about 22 inches, and a length of about 5 feet. As with all other parts of the shell halves 12, 14, the base portions 120, 121 are preferably made from plastic, such as a polyethylene plastic.

Although the base portions 120, 121 are generally planar, each includes a plurality of surface features. These surface features are designed primarily to stiffen the shell halves 12, 14 and make them rigid, and less subject to problems such as “oil canning”. These surface features 124 include a plurality of chevron shaped stiffening ribs 124. The stiffening ribs 124 comprise areas that are generally disposed in parallel planes with, but not co-planar with the remainder of the base portion 120. In addition to the chevron shaped stiffening ribs 124, the device also includes raised stiffening portions 126 that are disposed in either of the ends of the base portion 120.

A centrally disposed hexagonal stiffening rib 128 is disposed in the center of one or both of the base portions 120, 121. The hexagonal shaped stiffening member 128 is provided not only to impart additional stiffening to the base portion and rigidity, but also to serve as a frame, that forms an interior into which a branding indicia 129 (here shown as TT) can be disposed. The branding indicia 129 can take the form of the name and information about the manufacturer, and may include any trademarks under which the case 10 is sold. Alternately, the branding indicia may include materials such as warnings or instructions.

Each of the exterior portions 18, 30 of the shell halves 12, 14 respectively, include first long side portions 130, 131, second long side portions 132, 133 first short side portions 134, 135, and second short side portions 136, 137 respectively.

The long side portions 130-134 are each about 5 feet in length, and about 5 inches in height. Each of the short side portions 136-139 are approximately 22 inches in length, and about 5 inches in height.

All of the side portions 130-139 include surface features, such as stiffening ribs 140. The stiffening ribs 140 include portions that are disposed out of the primary plane of the various surfaces, and help to provide strength and structural rigidity to the case 10.

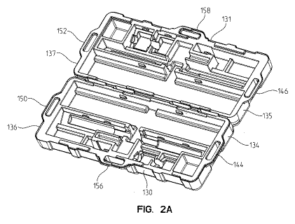

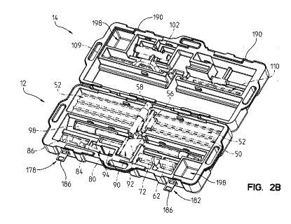

The first long side portions 130, 131 each also include a first latch 178 and a second latch 180, respectively, as shown in FIG. 6. Turning now to FIG. 2B, it will be noted that the first latch 178 comprises a first latch half 186 disposed on shell half 12, and a second latch 190 disposed on the second shell half 14. Similarly, second latch 182 also includes a first latch member 186 disposed on the first shell half and a second latch member 190 disposed on the second shell half 114.

A variety of different latch types 178, 182 can be used. Preferably, the latch provides a secure connection between the first and second shell halves 12, 14, when the case 10 is in the closed position. Most preferably, the latch 178, 182 provides a locking mechanism, so that the user can lock the case closed, when she so desires.

The second long side portion 132, 133 includes hinge members that, as will be described later, hingedly couple the first and second shell halves 12, 14 together, so that the shell halves 12, 14 can pivotably move about the hinge between a closed position, as shown in FIG. 6, and an open position as shown in FIG. 2B.

The exterior surface also includes first short side portions 134, 135 and second short side portion 136, 137. When in a closed position, it will be appreciated that, for example, the first short side portions 134, 135 are placed adjacent to each other in a generally planar relationship. The same is true with respective first long side portions 130, 131, second long side portions 132, 133, and second short side portions 136, 137 of the respective first and second shell halves 12, 14.

The case 10 also includes a plurality of handle members that, when fully assembled, include first and second short side handles and a first long side handle.

The first short side 134 of the first shell portion 12, includes a first short side handle member 114 that is sized and configured to matingly engage a first short side handle member 146 disposed on the first short side 135 of the second shell half 14. Similarly, a second short side handle member 150 is formed on the short side portion 136 of the first shell half 12, that is sized and configured to mate with a second short side handle member 152 that is formed on the second short side portion 137 of the second shell half 14. (See FIG. 3)

When the case 10 is in a closed position, as shown in FIG. 6, the first short side handle members 144, 146 matingly engage, as do the second short side handle members 150, 152 to form a generally unitary handle. Preferably, the short side handle members 144-152 are centrally located on the respectively short side portions.

Similarly, first long side handle member 156 is formed on the first long side of the first shell half 12, and the second long side handle member 158 is formed on the second long side of the second shall half 14. First and second long side handle members 156, 158 are configured to matingly engage when the handle members 156, 158 and the shall halves 12, 14 are in their closed position to form a unitary handle.

As best shown in FIG. 6, long side handle members 156, 158 are positioned generally at the center of the first long sides 130, 131 of the case 10. Because of the particular shape and size of the case 10, a user who grips the long side handle members 156, 158 can carry the case while walking, in much the same way that one would carry a large guitar case or other large musical instrument case. Given the size of case 10, and the normal distance between the user's hand and the ground, the user, when griping the handle 156, 158 will tend to hold the case 10 at a position above the ground, so that he can walk with the case 10 without the bottom of the case scraping the ground.

By contrast, the end handles 152, 146 are better suited for enabling two people to carry the case. Because of the size of the case 10 and the number of tools in the case, the case 10 can be rather heavy. By providing two end handles 146, 152, the case can easily be carried by two users, with one user grabbing the first handle 146 and the second user grabbing the second handle 152. This makes the case much easier to transport, especially when the case needs to be transported over long distances.

As shown in FIG. 10, grabbing one of the handles 152 of the short side, will also facilitate the user transporting the case 510 by rolling it. As will be noted in FIG. 10, an alternate embodiment case 510, includes a pair of ground engaging wheels 512, 514. The wheels 512, 514 are rotatably mounted with regard to the case 510 on an axle, so that one can grip the handle 152, and place the wheels 512, 514 on a surface. By pulling the handle 152, the case 510 can be rolled on the wheels 512, 514 to its desired location.

The size of the wheels 512, 514 of the case 510 shown in FIG. 10 will vary, depending upon the particular desires of the user manufacture. As will be appreciated, smaller wheels, such as caster-size wheels, will take up less space, and can be mounted quite easily on one of the shell halves 12, 14. However, as the case 10 is likely to often ben pulled over rough terrain, the rollability of the case may be improved if larger size wheels, such as baby coach or a small bicycle-sized wheels are used as wheels 512, 514, as such wheels would enable the case 510 to roll over dirt clods, gravel and other impediments of the type that one might find on an active construction site.

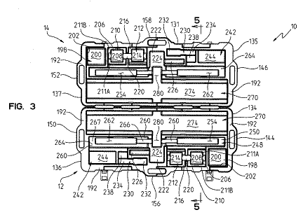

As shown in FIG. 4, the hinge that hingedly couples the first and second shell halves 12, 14 together will be explained. As discussed above, the hinge members are disposed generally along the second long side 132, 133 of the respective first and second shell halves 12, 14.

The hinge comprises a plurality of plastic molded first half female hinge members 164. Each of the first half female hinge members 164 preferably include an axially extending aperture extending there through. The second shell half 14 also includes a plurality of second half female hinge members 166, each of which also includes a central axially disposed apertures 168 therein.

The first half female hinge members 164 are sized and configured to be matable and alignable with the second half female hinge member 166, so that the respective first half apertures 165 and second half apertures 168, will be alignable in a co-linear relationship. By being placed in a co-linear relationship, a male hinge member, such as hinge pin 170, having a proximal end 174 and a distal end 176 can be inserted through each of the first female hinge member apertures 165 and second half female hinge member apertures 166. The male hinge member 170 serves as a hinge pin, that serves as a hinge axis about which the female hinge members 164, 166 can rotate, and hence, the first and second shell halves 12, 14 can rotate and hingedly move, between their respective closed position, as shown in FIG. 6, and their open position as shown in FIG. 2B.

As will be noted, the first female hinge members 164, 166 are disposed generally all along a significant portion of the second long side portion 132, 133 of the respective shell halves 12, 14.

When so configured, the hinge members 164, 166, 170 comprise a “piano hinge” type structure, so named because of the hinge type that is often used in grand pianos to hingedly couple the lid of the piano to the base portion of the piano.

The interior portions including the first interior portion 18 of the first shell half 12 and the second interior portion 32 of the second shell half 14 will now be discussed.

In the embodiment of the case 10 shown in the drawings, the interiors are generally identical. As such, the cavities that are discussed with respect to the first shell half 12 are generally identical to the cavities discussed in respect to the second shell half 14. However, because of the placement of the two shell halves 12, 14 about each other in a hinged relationship, it will be noticed that the places of the respective cavities are changed. For example, it will be noted that the cavity 198 in the upper left hand corner of the second shell half 14 corresponds to the cavity 198 in the lower right hand corner of first shell half 12.

As will be discussed in more detail below, the cavities are generally sized and shaped and configured to contain and hold various concrete tools such as the concrete tools shown in FIGS. 1 and 2B. In addition to the tools shown therein, other tools exist that would likely fit well in the case. Such tools include things such as miter edgers, gutter hand-held tools, curb hand-held tools, and the like.

Because of the generally identical nature of the cavities, cavities that correspond in the first shell half 12 will be numbered identically in the second shell half 14. In this regard, you should note that first cavity 198 in shell half 12 (in the lower right hand corner of the drawing) corresponds to the first cavity 198 of shell half 14, that is shown in the upper left hand corner of the drawing.

A plurality of cavities exist, that will be discussed herein, and referred to as various numbers (e.g. first cavity, second cavity, etc.).

It is important to note that the various cavities are recessed relative to the upper most plane of the interior portions of the first and second shell halves 12, 14. This “upper most portion” of the interiors is defined generally by the perimetral ledge 192, that generally extends around the perimeter of the interior portions 18, 32 of the first and second shell halves 12, 14.

For purposes of this discussion, the perimetral ledge 192 will generally be referred to as the highest point of the interior portions 18, 32. Relative to the perimetral ledge 192, all the cavities are recessed. That is, the base portions of the cavities, such as base portions 200 (of first cavities 198) are positioned closer to the base portions 220, 221 of the exterior surface than is the perimetral ledge 192.

As a convention for this application, stating that a certain part of a component is “more recessed”, suggests that it is positioned lower, and closer to the base portions 220, 221 of the exterior portions 16, 30 of the case. By contrast, stating that a portion of the cavity is relatively raised (relative to a more recessed portion) infers that the level of the “relatively raised” portion is more closely disposed to the height of the perimetral ledge 192.

Each of the first and second shell halves 12, 14 includes a first cavity 198, that is sized and positioned for holding tools such as a groover 62, or edger 72. Additionally, a tool such as a gutter tool or a curb tool would also likely fit into first cavity 198. First cavity 198 generally has a dimension of about 5 inches by 5 inches or so, and includes a generally planar base portion 200 that is disposed in a plane generally parallel to the plane in which the perimetral ledge 192 exists. A perimetral sidewall 202 defines the cavity 198, and connects its upper lip, with the relatively recessed base portion 200.

The second cavity 206 is disposed adjacent to the first cavity 198. Second cavity 206 is also sized to be approximately 5 inches by 5 inches and is designed to hold either groover 62 or edger 72.

The second cavity 206 includes a generally planar base portion 208 that is recessed from the perimetral ledge 192, and is disposed in a plane generally co-planarly with the base portion 200 of the cavity. Surrounding the planar base portion 208 is a angled tool receiving ridge 210. The angled tool receiving ridge 210 defines a plane that is disposed at an angle to the plane in which the first perimetral ledge 192 is disposed, and is also at an angle to the plane in which the planar base 208 is disposed.

The angled tool receiving ledge 210 includes a relatively recessed portion 211A, and a relatively raised portion 211B. As will be noted, relatively raised portion 211B is disposed closer to the first long edge 130, 131, whereas the relatively lower portion 211A is disposed closer to the second long edge.

This angled plane ledge 210 places an edger 72 that is placed thereon at an angle. By placing the edger 72 at an angle, it takes up less lateral space, thus increasing the capacity of the interior of the case 10.

The third cavity 212 is generally similar to the second cavity 206 and also includes a planar base portion 214, and an angled tool receiving ledge 216. Angled tool receiving ledge 216 is sized and positioned to configure a tool co-planarly with a tool configured on perimetral tool ridge 210 of cavity 206. This third cavity is generally similarly sized to cavity 206. Third cavity 212 is also sized for holding a groover 62 or an edger 72.

A hemi-cylindrical cavity 220 extends between the planar base portions 208, 214 of the second and third cavities 206, 212. The hemi-cylindrical portion 220 comprises a rod gripping cavity, that is sized for holding or gripping a rod-like member, such as short broom handle rod 102. Because the base of the hemi-cylindrical rod gripper portion 220 is generally at the same level as the base portions 214, 208, and a portion of the rod gripper portion 270 is below the level of the tool engaging ridges 210, 212, a rod having a diameter of approximately 1 inch or less can be positioned to reside in the rod gripping portion 220, while still being positioned under the blades of any tools, such as edgers or groovers, that are placed on the tool engaging ridges 210, 212.

A fourth cavity 222 is centrally located within the interior portion. The fourth cavity 222 is designed for holding a short broom, such as broom 90. The fourth cavity 222 includes a generally planar-based broom head receiving portion 224 that is sized and shaped for receiving broom head 94 and an elongated broom handle receiving portion 226 that is sized and configured for receiving a broom handle 94.

To better understand the relation of the cavity to the tools, and the placement of the tools in the cavity, your attention is directed to FIG. 2B, that shows the tools in the various cavities.

The fifth cavity 230 is sized and configured for receiving a tool such as a trowel 80. The fifth cavity 230 includes a blade holding portion 232, and a handle holding portion 234. The blade holding portion 232 and handle holding portion 234 are disposed at different levels, since one viewing the trowel 80 (FIG. 1) will notice that the handle 84 is positioned in a different plane than the blade 82.

The sixth cavity 238 comprises a small, generally rectangular cavity. The sixth cavity 238 is preferably designed to hold a small rectangular object, such as a tape measure or the like.

The seventh cavity 242 is generally rectangular in configuration, and includes a generally planar base portion 244 that defines a plane that is generally parallel to plane 192 of the perimetral ledge. Seventh cavity 242 is sized and configured for holding a small float, such as small float 86.

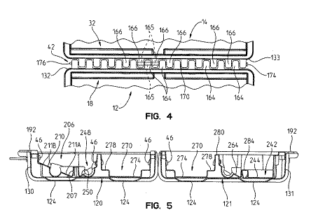

As shown in FIG. 5, it will be noted that protrusions, such as protrusion 46, exist in some of the cavities, such as 208. It will be noted that protrusion 46 is disposed adjacent to the tool receiving ledge 210, but is spaced there from. Preferably, the blade of the tool on tool receiving ledge 210, such as the blade 64 of edger 68, is placed between the protrusion 46B and the surface 211B of the tool receiving ledge 210. This placement of the tool blade between the protrusion 46B and the upper surface 211B of tool receiving ledge 210 helps to hold the edger 62 within the cavity. As one edge of the edger 72 is engaged between the protrusion 46 and surface 211B, the other edge of the edger 72 is wedged against wall 207.

Returning back to FIGS. 1 and 3, it will be noted that the interior includes an eighth cavity 248 that is generally elongate and rectangular, and is sized and configured for holding a hand float, such as either hand float 110, or hand float 108 shown in FIG. 1. The eighth cavity 248 includes an angled tool receiving surface 250 that is generally similar to the angled tool receiving surface 210 associated with cavity 208.

The lower surface of the blade 112 of the float 110, or the lower surface of blade 109 of float 110 preferably rests on the upper surface of the angled tool receiving surface 250.

Disposed beneath, and at a lower level than the angled tool receiving surface 250 is a recessed hemispherical rod receiving portion of the eighth cavity 248. It will be noted that the recessed hemispherical rod receiving portion 254 extends generally continuously across the interior of the portion of the interior, and is aligned with the recessed hemispherical rod receiving portion 262, so that a long rod, such as broom handle-like rod 98, can be placed in the eighth and ninth cavities so that a portion of the elongated rod 98 is disposed in an elongated rod receiving cavity portion 254, whereas the other end portion is received in hemispherical rod receiving portion 262.

It will be noted that each of the rod receiving portions 254, 262, include centrally disposed extension portions 266. These extension portions 266 help to maintain the continuity, and co-linearity of the rod receiving portions 254, 262.

The ninth cavity 258 is a mirror image of the eighth cavity 248 and also includes an angled tool receiving surface 260, that is generally co-planar with the angled tool receiving surface 250 of the eighth cavity. Both tool receiving surfaces 250, 260 are angled, so that the relatively more recessed portion 264 is disposed closer to first edge 130 and the relatively raised portion 267 is disposed closer to the second edge of the shell half 12, 14.

The tenth cavity 270 is the largest cavity within the interior portion and extends generally the entire length of the interior portion. The tenth cavity 270 is large to accommodate the large width of a bull float 50 blade 52. As will be appreciated by those skilled in the art, a typical bull float blade 52 has a width that is somewhere between 4 and 4½ feet.

The large tenth cavity 270 includes a planar bottom surface 274 that receives the lower planar surface of the bull float 50, blade 52.

It will be noticed that there is also a perpendicular portion 280 of the tenth cavity 270. The perpendicular portion 280 has a length that extends generally at a perpendicular angle to the primary axis of the bull float 50 blade 52. The perpendicular portion serves primarily as a cavity for receiving the rod portion 58 and bracket 56 of the bull float.

The rod 58 of the bull float extends a significant distance above the blade portion 52 of the bull float 50. As such, when the case 10 is placed in its closed position, a bull float blade 52 that is in the tenth cavity 270 of the first shell half 212, will have its rod portion 58 positioned, so that it is received in the perpendicular portion 280 of the second shell half 14.

It will be noted that cavity 270 also includes a raised perimetral tool engaging ridge 278, that raises the blade of a tool resting there on, slightly above the relatively recessed base portion 274 of cavity 270.

It will also be noted that a plurality of protrusions 46 exist along the side walls of several of the cavities. These protrusions, as discussed below, engage the blades of the various tools, to help maintain the tools within their cavities.

Turning now to FIG. 2B, there is shown a good representation of how the various tools sit within their respective cavities, that helps illustrate an appropriate placement of the tools within the interior portion of the case.

Turning now to FIG. 5, a cross sectional view of the device is shown. The cross sectional view shown in FIG. 5 is of a device wherein the shell half 12, 14 are each unitarily formed in the process, such as rotation molding, or some other molding process that can make the shell halves 12, 14 as one-piece units. It will also be noted that the cavities are separated by several vertical walls, such as vertical walls 280, 284 that separate one cavity from another. FIG. 5 is also important as it illustrates the plane formed by the perimetral ledge 192, and the relative recess of the cavities relative to the perimetral ledge 192, and the angling of certain planes, such as a tool engaging surface 264, relative to plane 192.

An alternate embodiment construction technique is shown in FIG. 7.

FIG. 7 shows an alternate embodiment wherein the device is made by a vacuum form process. As being made by a vacuum form process, each of the shell halves are made of two pieces. An exterior piece 308 is made that includes the side walls and the base portion. The interior portion is made from a second vacuum form piece 306. The interior piece 306 is then mated to the exterior piece 308, such as by gluing or some other joinder technique. Vacuum forming has the advantage of having substantially lower mold costs, although it is believed by the applicant that the rotational single piece molding will ultimately result in a better product.

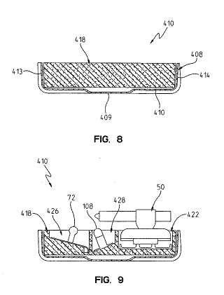

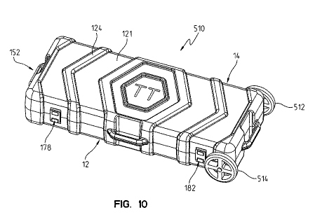

A second alternate embodiment is shown in FIGS. 8 and 9. FIG. 8 shows a case 410 that is made from a unitarily formed exterior 408. A foam block 418 is placed in the exterior tub 408. The exterior tub 408 includes a base portion 409 that includes stiffening member 410. It also includes side walls, such as side wall 413 and side wall 414. The foam block 418 is preferably a foam type that can be cut so that cavities can be formed that are appropriate for holding the tools.

There are two ways in which such a foam-containing case 418 can be sold. In some cases, one may wish to sell the case 410 with an uncut foam block 418. By selling the case 410 with an uncut foam block, the user can cut cavities into the foam block 418 that mate with the tools that he has. Alternately, the device 410 can be provided with a foam block 418 that has cavities cut into it. Turning now to FIG. 9, a case 410 having a foam block 418 into which cavities are cut is shown.

FIG. 9 shows a foam block having a large cavity 422 cut therein into which a bull float 50 is placed.

Although not shown that well in the drawing, it is preferred that the cavity have a width that is slightly less than the width of the bull float blade 52. By so doing, a soft, pliable foam will tend to “squeeze” on the bull float blade 52 to thereby help to maintain the blade 52 in the cavity 422. A smaller central cavity 426 is provided into which a tool, such as edger 72 is placed. It will be noted that the edger 72 is placed perpendicular to its normal orientation. Further, a cavity having an angled plane base surface 428 is shown that includes an angled base portion that is provided, for holding a tool such as float 108.

It will also be appreciated that although the configuration shown in the drawings for the various cavities represents the best mode perceived presently by the Applicant configuring the cavities, other cavity configurations might also exist that serve the intended function.

Having described the invention with respect to certain preferred embodiments, it will be appreciated that these embodiments are not intended to be limiting, but that the invention is defined and limited only by the scope of the claims appended hereto.

What is claimed:

1. A case for holding a plurality of construction tools, the case comprising
a first shell half having a first exterior portion and a first interior portion, the first interior portion defining a plurality of cavities sized and shaped for receiving construction tools,
a second shell half having a second exterior portion and a second interior portion
a hinge for hingedly coupling the first shell half to the second shell half for permitting the first and second shell halves to move relative to each other between a closed position and an open position, and
a retaining protrusion disposed on the interior portion and engageable with a construction tool for retaining a construction tool in at least one of the plurality of cavities.

2. The case of claim 1 wherein the first interior portion includes an upper surface disposed in a plane, and the at least one cavity of the plurality of cavities includes a base portion disposed in plane angled from the plane of the upper surface.

3. The case of claim 2 wherein the at least one cavity includes a side wall portion, and the retaining protrusion is disposed on the side wall portion to extend outwardly therefrom.

4. The case of claim 3 wherein the retaining protrusion is disposed adjacent to the angled base portion and is sized and positioned for engaging a blade of a construction tool.

5. The case of claim 4 wherein the construction tool is selected from the group consisting of trowels, floats, bull floats, jointers, trowels, and edgers.

6. The case of claim 1 wherein at least one of the plurality of cavities includes a sidewall portion, and the retaining protrusion is disposed on the side wall portion, and extends outwardly therefrom.

7. The case of claim 1 wherein the exterior portion comprises an outer shell member having a plurality of surface features for increasing structural rigidity of the exterior portion.

8. The case of claim 1 wherein the first shell half includes a plurality of integrally formed female hinge members, the female hinge members being matable with a male hinge member for forming the hinge.

9. The case of claim 8 wherein the second shell hall includes a plurality of integrally formed female hinge members, the female hinge members of the first shell half being matable with the female hinge members of the second shell half.

10. The case of claim 9 wherein each of the female hinge members of the first and second shell halves include apertures, the apertures of the female hinge members of the first shell half being coaxially alignable with the apertures of the female hinge members of the second shell half for receiving a generally linear hinge pin male member.

11. The case of claim 10 wherein the male hinge pin and female hinge members form a piano-hinge type hinge.

12. The case of claim 1 wherein the first exterior portion is separable from the first interior portion, for permitting the first exterior portion to be mated with one of a plurality of differently configured first interior portions.

13. The case of claim 12 wherein the first exterior portion is bowl-shaped, and the first interior portion comprises a foam member insertable into an interior of the bowl-shaped first exterior member.

14. The case of claim 12 wherein the first exterior portion includes a base portion disposed generally in a plane and a sidewall portion disposed in planes generally perpendicular to the plane in which the base portion is disposed, wherein the interior portion comprises a shot-like member formed to include a plurality of cavities, and including a peripheral lip sized and shaped to be coupled to the side wall portions of the base portion.

15. The case of claim 10 wherein the exterior and interior portions of the first shell half are uniformly formed in a single molding process to create a one-piece first shell half.

16. The case of claim 1 wherein the interior portion of the second shell half includes a plurality of cavities sized and shaped for receiving construction tools.

17. The case of claim 16 wherein each of the first and second shall halves comprise unitarily formed one-piece shell half members.

18. The case of claim 1 further comprising at least one latch member for coupling the first shell half to the second shell half to maintain the first and second shell halves in the closed position.

19. The case of claim 1 further comprising a wheel member coupled to the case, and a handle member coupled to the case for permitting a user to transport the case by rolling it on the wheel member.
